(19) United States
(12) Patent Application Publication
(10) Pub. No.: US 2006/0026005 A1
(43) Pub. Date: Feb. 2, 2006

(54) Method for forming risk management contracts by means of a computer system

(76) Inventor: Mikhail Anatolievich Rogov, Moscow (RU)

Correspondence Address: JACOBSON HOLMAN PLLC, 400 SEVENTH STREET N.W., SUITE 600, WASHINGTON, DC, 20004, US

(21) Appl. No.: 10/536,423

(22) PCT Filed: Nov. 26, 2002
(86) PCT No.: PCT/RU02/00509

§ 371 Date: May 26, 2005

(51) Int. Cl. G06Q 99/00

(52) U.S. Cl. 705/1

(57) ABSTRACT

The invention relates to operations on options and other derivatives carried out by means of a computer system for managing risks of event, operation risks, market jump risks and discloses a method for formulating derivatives with respect to solar and geomagnetic activity or the derivative indexes thereof, including options and futures of sunspot numbers (solar derivatives). The inventive method consists in receiving data for a given asset, type of contract, strike price for a given asset, current price of a given asset, lower bound of a change, current interest without non-payment risk, price dispersion of a given asset during the quotation thereof and a required guarantee fee therefor, and in defining a derivative for each variable of the derivative cost computation algorithm, a variable strike price associated with a current price and in defining a variable strike price together with a strike price. The difference between the trade price of the contract and a final closing price is defined and data for said distributable difference is sent to the user, the difference between the strike price and the current price of a given asset is defined and the data for said distributable difference is sent to the user.

### FIELD OF INVENTION

The present invention relates generally to transactions on options and other derivatives implemented on computer system for event, operation and market jump risk management and more particularly to a method for formulation derivatives based on solar and geomagnetic activity measures or parameters made from them including sun spot number futures and like (sun derivatives).

### SUMMARY OF INVENTION

A derivative is an investment vehicle whose value is based on the value of underlying asset. That is, a derivative is essentially a financial instrument that is derived from the future movement of something that cannot be predicted with certainty. Among derivatives are futures contracts, forward contracts, options, swaps, swaptions and others.

Investors, to increase overall portfolio return or to hedge or revoke portfolio risks, typically use derivatives. Banks, companies, organizations, and the like to protect against market risks in general, also frequently use derivatives. Derivatives help in managing risks by allowing such banks, companies, organizations, and the like to divide their risk into several pieces that may be passed off to other entities who are willing to shoulder the risk for an up-front fee or future payment stream.

In 1997 a new type of derivative emerged—a weather derivative. A weather derivative is a contract whose value is based on the fluctuations in temperature or the accumulation of a type of precipitation (e.g. rain, showers, snowfall etc.).

For example, a computer implemented method is known for evaluating a weather-based financial instrument, comprising the steps of: receiving information representative of a start date and maturity date for the financial instrument; receiving information representative of a geographic region to be covered by the financial instrument; receiving information representative of a weather condition that the financial instrument will derive its value from; receiving information representative of a risk-free rate; receiving historical weather information, relating to said weather condition, for said geographic region during the period between said start date and said maturity date; receiving future weather information, relating to said weather condition, for said geographic region during the period between said start date and said maturity date; and obtaining a value of the financial instrument by applying a pricing model using said historical weather information, said future weather information, and said risk-free rate (U.S. Pat. No. 6,418,417, G 06 F 17/60, Sep. 7, 2002).

Also a method is known for formulation of risk management contracts implemented on a computer system, performed by the process of receiving signals from the user, wherein said signals are representative of data for a particular (base) asset, data for an option type, data for an exercise (strike) price for the particular (base) asset, data for the current (spot) price of the particular (base) asset, data for the minimum value of a movement in the price of the underlying asset (tick value), data for the current risk-free interest rate, data for the historic price volatility of the particular asset and the margin requirement for the particular (base) asset, setting each variable of the option premium algorithm to its associated data value received before that, variable of the exercise (strike) value based on the current (spot) price from said signal, generating data representative of an option premium, setting variable of the exercise (strike) value from said signals. (RU Pat. No. 2176817, G06F 17/60, Oct. 12, 2001)

Though existing types of derivatives including weather derivatives serve as good risk management tools for market and some other risks, there are not enough instruments for operation, event risks (e.g. risks of devices failures, terrorism and others) and for that market volatility jump risk, which sometimes is called “market jump risk”, which can not be hedged enough easy and confidently.

The purpose of the present invention is more easily and confidently hedging some kinds of operation, event and market jump risk factors and creation of an opportunity for firms to hedge the specified risks by means of invented tools and for speculators to trade these risks and make profit using computer system.

The purpose reached by the method for formulation of risk management contracts implemented on computer system comprising the steps of: receiving signals from the user, wherein said signals are representative of data for a particular (base) asset, data for a contract type, data for an exercise (strike) price for the particular (base) asset, data for the current (spot) price of the particular (base) asset, data for the minimum value of a movement in the price of the underlying asset (tick value), data for the current risk-free interest rate, data for the historic price volatility of the particular asset and the margin requirement for the particular (base) asset, setting each variable of the derivative premium algorithm to its associated data value received before that, setting variable of the exercise (strike) value based on the current (spot) price from said signal, generating data representative of a derivative premium, setting variable of the exercise (strike) value from said signals, which differs from prototype by:

further comprising the step of receiving signals which are representative of data for solar and geomagnetic activity measures or parameters made from them as the said signal which is representative of data for a particular (base) asset,

further comprising the step of receiving signals which are representative of data for an exercise (strike) price for solar and geomagnetic activity measures or parameters made from them as the said signal which is representative of data for an exercise (strike) price for the particular (base) asset,

further comprising the step of receiving signals which are representative of data for the current (spot) value of the solar and geomagnetic activity measures or parameters made from them as the said signal is representative of data for the current (spot) price of the particular (base) asset,

further comprising the step of receiving signals which are representative of data for the minimum value of a movement in the value of the solar and geomagnetic activity measures or parameters made from them as the said signal is representative of data for the minimum value of a movement in the price of the underlying asset (tick value),

further comprising the step of receiving signals which are representative of data for the historic price volatility of the solar and geomagnetic activity measures or parameters made from them as the said signal is representative of data for the historic price volatility of the particular asset and the margin requirement for the particular (base) asset,

further comprising the step of calculation of a difference between the traded price of the futures contract and the final closing value and outputting to the user the signal which is representative of data for said difference, which should be transferred between the buyers and sellers.

And the method, further comprising the step of receiving signals which are representative of data for a type of the contract, start date of the contract, maturity date of the contract, contract value, additional details of the derivative contract.

And the method, wherein said signal received from the user which is representative of data for additional details of the derivative contract is a signal which is representative of data for currency, geographic region, counterparties of the contract.

And the method, wherein said signals received from the user which are representative of data for solar and geomagnetic activity measures or parameters made from them are signals which are representative of data for month average sun spot numbers.

And the method, wherein said signal is representative of data for the contract type selected from the group consisting of: a put or a call or a futures or a forward or a swap.

And the method, wherein said signals received from the user which are representative of data for solar and geomagnetic activity measures or parameters made from them are signals which are representative of data for influence of the astronomic and geophysical measures.

There are two reasons for the invented new type of derivative (risk management contracts based on solar and geomagnetic activity measures or parameters made from them including sun spot number-based futures, options, swaps, and the like sun derivatives).

First of all, there are some risk factors, which depend on solar and geomagnetic activity, e.g. heart attacks, human errors, radio-electronic devices failures etc.

Geomagnetic storms influence current of a lot of diseases: diseases of cardiovascular system (hypertension, a stenocardia, a heart attack of a myocardium), lung diseases (chronic nonspecific lung diseases, a tuberculosis); blood system, a psycho-emotional condition (a syndrome of psycho-emotional pressure); changes of biorhythms.

During the periods of solar-geomagnetic fluctuations, an aeroionic state of the ground air dramatically changes which results in changes of psycho-physiological reactions of person, in growth of operator errors in “critical days”. On days of high solar activity complex equipment fails, the probability of errors of the operators working on this equipment rises.

Analysis of industrial crash and transport incidents statistics confirms it—on days of magnetic storms mortality level rises 5-6 times, fires and failures level for heating systems, gas and water supply pipelines, electric power lines, rises 4-5 times.

Geomagnetic storms can break work of a satellite communication, systems of electric power distribution; they can increase corrosion of oil pipelines, complicate magnetic investigation of minerals.

These risk factors play important role in many areas of business, e.g. medicine and pharmacy, aircraft and other transport, industry and retails, insurance and reinsurance etc.

Secondly, it is world wide known since A. Chizhevsky published his works in 1915, that there is a correlation between epidemic cycles, economical cycles, agricultural prices movements, wars, revolutions and other accidents (e.g. acts of terrorism etc.) on one hand and solar or geomagnetic activity cycles on the other hand.

So the offered derivatives may become a unique market instrument, which may cover different operation risk factors, event risk and market jump risks. Firms may try to hedge these risks by means of the instruments and speculators may trade these risks and make profit.

The nearest analogues to the invented instruments are weather derivatives but there is a great difference in covered risk factors. Weather derivatives based on the fluctuations in temperature or the accumulation of a type of precipitation and do not cover above-mentioned risk factors as well as the offered instruments based on solar and geomagnetic activity measures or parameters made from them.

Sun derivatives may be utilized, for example, by pharmaceutical company as a hedge against raised demand or by insurance company to hedge against future policyholders' claims. Unlike insurance policies, however, the entity purchasing a derivative contract does not have to prove any actual loss. The purchaser of an options-type derivative, for example, would only need to show that the measure of solar and geomagnetic activity or parameters made from it called for in the contract went above or below the specified execution (“strike”) value (i.e., a numerical value that triggers payment). In contrast, the other party to the contract (i.e., the seller) would be expecting that the measure of solar and geomagnetic activity or parameters made from it called for in the contract is not going to go above or below the specified execution (“strike”) value.

Among modern solar and geomagnetic activity measures there are the oldest and the most famous sun spot numbers offered by R. Wolf in 1851-1852, who discovered 11-year cycles of sun activity. This indicator of quantity of sun spots may be used as an example of base asset for derivatives.

One possible model of such derivative (Sun Spot Number Futures Contract) is offered here.

Sun Spot Number Futures Contracts may be based on the daily sun spot numbers (DSN) and monthly averaged sun spot numbers (MASN). DSN is a term equal to Wolf's sun spot number. The MASN is the average spot number for that month.

Such contracts may be cash settled. Cash settlement means that at the maturity of each contract, it is calculated a difference between the traded price of the futures contract and the final closing value based on the MASN. This difference should be transferred between the buyers and sellers in cash.

In order for sun derivatives to operate in an open market, parties have to agree on the recorded solar and geomagnetic activity measures or parameters made from them (e.g. sun spot numbers) for each day within the contract period. Therefore, organizations or government entities, such as the World Data Center-A for Solar-Terrestrial Physics for example, serve as record keepers for each days' official sun spot numbers or other solar and geomagnetic activity indices to avoid legal disputes.

Companies whose revenues and profits are affected by changes in solar and geomagnetic activity should seek to hedge their operation, event and market jump risks using these risk management instruments. These include:
1). any companies and institutions, for hedging operation risks, including terrorism, strikes, local war, regional and political risks, other event risk etc.;
2). tourist, aircraft, industry companies and other companies where adverse solar and geomagnetic activity could impact on crashes due to operator's errors, radio-electronic devices failures, etc.;
3). medicine and pharmaceutical companies where supply and demand is highly correlated to changes in the sun spot numbers;
4). agricultural producers, agricultural merchants and traders, food manufacturers and agricultural input suppliers where adverse solar and geomagnetic activity could impact output and price:
5). retail, media, public relations, advertisement companies and institutes where customers' purchasing behavior is affected by change in sun spot number;
6). insurance and reinsurance companies, pension funds for portfolio risk diversification.

The invented method may be implemented on apparatus described in patent RU Pat. No. 2176817, G06F 17/60, Oct. 12, 2001 that serves as a prototype.

Example of Realization of the Invented Method

A variant of invented sun derivative (i.e., sun spot number futures) contract may be implemented as follows:

Parties agree on the following terms:

Parties of the Contract: A and B.

Type of the Contract: Futures Contract

Base asset: Monthly averaged spot number (MASN) for January 2003

Start date: 1 Oct. 2002

Maturity date: 31 Jan. 2003

Contract Value=$3,000.00

Strike Value=110.0

Tick size=0.1

At the maturity of each contract it is calculated a difference between the traded price of the futures contract and the final -closing value based on the MASN in accordance with following algorithm: Spot=MASN at maturity (or current date) if Spot>Strike: A receives {Contract value×(Spot−Strike)} if Spot<Strike: B receives {Contract Value×(Strike−Spot)} if Spot=110: The parties exchange no money

For example, 31 Jan. 2003, Parties calculate a difference between the traded price of the futures contract and the final closing value based on the MASN in accordance with following algorithm: if MASN>110.0: A receives {$3,000.00×(MASN−110.0)} if MASN<110.0: B receives {$3,000.00×(110.0−MASN)} if MASN=110: The parties exchange no money

Example Numbers: if MASN=111.0: Party A receives $3,000.00 from Party B if MASN=90.0: Party B receives $60,000.00 from Party A

As will be apparent to one skilled in the relevant art(s), other scenarios are possible. For example, party A may pay an up-front cost (e.g., $1,000.00) to enter into an options contract. Thus, in such a scenario, if the MASN is below a strike value, A loses the up-front payment but pays nothing else.

Situation

On 1st October, a US domestic medicament supplier (who supplies medicaments to pharmacies) has become concerned about a risk to its revenues for the month of January. In-house forecasters have predicted more sun spots than average in winter, which would mean a greater than normal demand for cardiac medicaments, which the supplier would need to buy at a potentially higher price.

Assumptions
1. The medicament supplier has 800 pharmacies.
2. The average yearly usage per pharmacy is 60,000 units of the cardiac medicament, of which approximately 10% are used in the month of January.
3. For each unit of change in monthly average sun spot number, there will be a corresponding change of 5% in the expected demand for the cardiac medicament.
4. Forecasters predict overall that the sun spot number averaged for January will be higher than the normal average sun spot number.
5. The medicament supplier has a fixed sale price of $3.5 per cardiac medicament unit.
6. Current January the cardiac medicament purchase price is $2.5 per unit (as on 1st October).
7. Historical data indicates that if January average sun spot number is lower than average, the potential cardiac medicament price could be $4.0 per unit.

Actions

As a more active sun is predicted for January, the medicament supplier may decide to sell Sun Spot Number Futures as a hedge against potential losses due to increased demand and potentially higher cardiac medicament prices due to higher sun spot numbers.

Calculation of Hedge Requirement 800 (pharmacies)×60,000 (units per annum)×10% (January load)×5% (Volume change per unit of monthly sun spot number)=240,000.00 units (increase in cardiac medicament demand for unit change in the monthly sun spot number). 240,000×$1.0 (Change in the cardiac medicament price)=$240,000.00.

A Sun Spot Number Futures contract covers the risk of $3,000.00 per unit change in average monthly sun spot number. So the number of contracts needed to hedge this potential loss is $240,000.00/$3,000.00=80 contracts.

So the medicament supplier sells 80 lots January Sun Spot Number Futures Contracts.

In summary, the medicament supplier, by selling the Sun Spot Number Futures, is protected against an increased demand for cardiac medicament due to the lower than normal monthly sun spot number.

Case 1.—The MASN is above normal by one unit (for example 111.00 instead 110.00) Increased cardiac medicament demand 240,000 units×$3.5 per unit=$840,000.00 Revenue from increased cardiac medicament demand 240,000 units×$4.0 per unit=$960,000.00, Loss=($120,000.00) Loss of profit (had the cardiac medicament been purchased at $2.5)=($120,000.00) Profit realized from movement of Sun Spot Number Futures by unit 80 lots×$3,000.00=$240,000.00 Net result=$0.00

Case 2.—The MASN is normal (for example, 110.00). Sun Spot Number Futures liquidated at original price giving no profit or loss=$0.00

Realization of the transaction on sun derivative implemented on computer system (for example, sun spot futures contract) assumes:

a) receiving by central server (for example, at an exchange) signals from user (for example, futures seller—the medicament supplier), which are sent through computer network to the central server and which contain data:
of type of the contract, for example: Futures Contract,
of base asset, for example monthly averaged spot number (MASN) for January 2003,
of start date, for example: 1 Oct. 2002,
of maturity date, for example 31 Jan. 2003,
of contract value, for example $3,000.00,
of strike value, for example 110.0,
of tick size, for example 0.1,
of additional details of the contract, for example, payment currency, for example, US Dollars, of current MASN value (spot), for example 110.0;

b) generation of a difference between the traded price of the futures contract and the final closing value in accordance with following algorithm: if Spot>Strike: A receives {Contract value×(Spot−Strike)} if Spot<Strike: B receives {Contract Value×(Strike−Spot)} if Spot=Strike: The parties exchange no money. Such calculations may be made on the same central server on its processor. For example, if MASN>110.0: the medicament supplier receives {$3,000.00×(MASN−110.0)}; if MASN<110.0: the exchange receives {$3,000.00×(110.0−MASN)}; if MASN=110: the parties exchange no money For example, MASN=111.0, medicament supplier receives $3,000.00 for each contract.

c) outputting from the central server (the exchange) for user (for example, the medicament supplier) a signal, wherein said signal is representative of data for the difference between the traded price of the futures contract and the final closing value which should be transferred between the buyer (for example, the medicament supplier) and sellers (for example, the exchange).

Similarly to the prototype, the apparatus for implementation of the invention includes means for receiving signals, wherein said signal is representative of data for type of the contract, base asset, start date, maturity date, contract value, strike value, tick size, additional details of the contract, current value (spot), a storage medium for data, means of receiving the signals, wherein said signals are representative of data and algorithm of calculation of the difference between the traded price of the futures contract and the final closing value, and means for outputting the signals for user, wherein said signals are representative of data for said difference which should be transferred between the buyer (for example, the medicament supplier) and sellers (for example, the exchange).

1. Method for formulation of risk management contracts implemented on computer system comprising the steps of:
receiving signals from the user, wherein said signals are representative of data for a particular (base) asset, data for a contract type, data for an exercise (strike) price for the particular (base) asset, data for the current (spot) price of the particular (base) asset, data for the minimum value of a movement in the price of the underlying asset (tick value), data for the current risk-free interest rate, data for the historic price volatility of the particular asset and the margin requirement for the particular (base) asset,
setting each variable of the derivative premium algorithm to its associated data value received before that,
setting variable of the exercise (strike) value based on the current (spot) price from said signal,
generating data representative of a derivative premium,
setting variable of the exercise (strike) value from said signals,
which is differ from prototype by:
further comprising the step of receiving signals which are representative of data for solar and geomagnetic activity measures or parameters made from them as the said signal which is representative of data for a particular (base) asset,
further comprising the step of receiving signals which are representative of data for an exercise (strike) price for solar and geomagnetic activity measures or parameters made from them as the said signal which is representative of data for an exercise (strike) price for the particular (base) asset,
further comprising the step of receiving signals which are representative of data for the current (spot) value of the solar and geomagnetic activity measures or parameters made from them as the said signal is representative of data for the current (spot) price of the particular (base) asset,
further comprising the step of receiving signals which are representative of data for the minimum value of a movement in the value of the solar and geomagnetic activity measures or parameters made from them as the said signal is representative of data for the minimum value of a movement in the price of the underlying asset (tick value),
further comprising the step of receiving signals which are representative of data for the historic price volatility of the solar and geomagnetic activity measures or parameters made from them as the said signal is representative of data for the historic price volatility of the particular asset and the margin requirement for the particular (base) asset,
further comprising the step of calculation of a difference between the traded price of the futures contract and the final closing value and outputting to the user the signal which is representative of data for said difference, which should be transferred.

2. The method according to claim 1, further comprising the step of receiving signals which are representative of data for a type of the contract, start date of the contract, maturity date of the contract, contract value, additional details of the derivative contract.

3. The method according to claim 2, wherein said signal received from the user which is representative of data for additional details of the derivative contract is a signal which is representative of data for currency, geographic region, counterparties of the contract.

4. The method according to claim 1, wherein said signals received from the user which are representative of data for solar and geomagnetic activity measures or parameters made from them are signals which are representative of data for month average sun spot numbers.

5. The method according to claim 2, wherein said signal is representative of data for the contract type selected from the group consisting of: a put or a call or a futures or a forward or a swap.

6. The method according to claim 1, wherein said signals received from the user which are representative of data for solar and geomagnetic activity measures or parameters made from them are signals which are representative of data for influence of the astronomic and geophysical measures.
